(19) United States
(12) Patent Application Publication
(10) Pub. No.: US 2011/0177751 A1
(43) Pub. Date: Jul. 21, 2011

(54) SIMULATED COSMETIC TOY

(76) Inventor: Heidi L. Miller, Burley, ID (US)

(21) Appl. No.: 12/689,943

(22) Filed: Jan. 19, 2010

(51) Int. Cl. A63H 33/00; B23P 17/04

(52) U.S. Cl. 446/296; 29/428

(57) ABSTRACT

A simulated cosmetic toy provides a real-make up experience while being mess-free and safe for a child. An element is selected to reproduce the physical properties of a real cosmetic composition, such as eye shadow, blush, pressed powder, lip color, and the like, and is disposed within a container to reproduce the experience of using a real cosmetic product.

### TECHNICAL FIELD

Embodiments of the present invention relate to a toy for a child that simulates the physical characteristics of real cosmetics compositions or products, and provides the child with the experience of using such compositions.

### BACKGROUND

Young children have always been interested in imitating the actions of adults, especially in their play. Little girls, in particular, often try to mimic their mothers by, for example, wearing their clothes and playing with their makeup.

Recognizing this interest, the cosmetics industry has increasingly targeted young children, especially girls, with various products designed just for them. The majority of play or toy make-up sold today includes real cosmetic compositions similar to those marketed and sold to adults. There are numerous drawbacks of using actual cosmetic compositions as a toy for children. Many of these products are messy and non-hypoallergenic. In addition, these products are sold as a toy and, thus, are not subject to approval by the Food and Drug Administration (FDA). Accordingly, kid's cosmetics often include potentially dangerous chemicals, additives and dyes, some of which have been linked to long-term health effects, allergic reaction and other skin-related problems.

A few toy cosmetics are being sold that include fake or “simulated” make-up, but do not accurately capture the look and feel of real cosmetics. For example, simulated make-up may be made from materials such as, paper, wood and plastic, which do not capture the experience of real make-up.

In view of the drawbacks associated with current products, a simulated cosmetics toy that provides a child with the experience of using a real cosmetic product, while being mess-free and safe, is desired.

### SUMMARY

Embodiments of the present invention include a simulated cosmetic toy that includes an element having a feel approximating that of a cosmetic product. The feel of the element may be selected or fabricated to reproduce at least one of a powder, a cream and a pressed powder. As a non-limiting example, the element may include at least one of a polymer material and a foam material and, additionally, may include a consolidated material that resists degradation or transfer upon contact. The element may include a single material or a plurality of materials, each having different physical properties. The simulated cosmetic toy may further include a case or an applicator to enhance the experience of using a cosmetic product.

Further embodiments of the present invention include a simulated cosmetic toy includes an element simulating at least one of an appearance of a cosmetic composition disposed within container. The container includes at least one apparatus for applying the cosmetic composition being simulated. For example, the element may be formulated to simulate a liquid cosmetic product, such as a nail polish or a lip gloss. The at least one apparatus may include, for example, a roller rotatably mounted within the container or a brush affixed to a cap of the container.

In additional embodiments, the present invention provides a method for producing a simulated cosmetic toy. The method may include selecting an element to approximate at least one of the appearance and feel of a real cosmetic product and disposing the element in a container. The element may be selected to have a feel similar to that of a powder composition or a cream composition.

### BRIEF DESCRIPTION OF THE SEVERAL VIEWS OF THE DRAWINGS

FIG. 1A is a cross-sectional view of a simulated cosmetic according to an embodiment of the present invention;

FIG. 1B is a top down view of the simulated cosmetic shown in FIG. 1A;

FIG. 1C is a perspective view of the simulated cosmetic shown in FIGS. 1A and 1B;

FIG. 2A is a cross-sectional view of a simulated cosmetic according to another embodiment of the present invention;

FIG. 2B is a perspective view of the simulated cosmetic shown in FIG. 2A;

FIG. 3A is a cross-sectional view of a simulated lip cosmetic according to yet another embodiment of the present invention;

FIG. 3B is perspective view of the simulated lip cosmetic shown in FIG. 3A.

FIG. 4A is a cross-sectional view of a simulated nail polish according to yet another embodiment of the present invention; and

FIG. 4B is perspective view of the simulated nail polish shown in FIG. 4A.

### DETAILED DESCRIPTION

The simulated cosmetics of the present invention provide a substantially mess-free and non-toxic toy for simulating or approximating the characteristics of a real cosmetic composition or a device containing such. The term “real cosmetic composition,” as used herein, refers to any substance or preparation intended to be placed in contact with the various surface parts of the human body, such as, the epidermis, hair system, nails and lips. Examples of such real cosmetic compositions include foundations, powders, blushes or rouges, bronzers, eye shadows, lipsticks, lip colors, lip glosses, and nail polishes. An element simulating the physical properties of a real cosmetic composition may be used to fabricate the simulated cosmetics described herein. For example, the element may approximate at least one of the feel, appearance, color, shape and texture of a real cosmetic composition. As used herein, the term “feel” refers to a quality of an object that is perceived by feeling or touching; or a physical sensation perceived though the sense of touch. By including an element that looks and feels like a real cosmetic composition, a child is provided with an enhanced play experience. The element may be formed from a consolidated material that resists or prevents transfer of the material providing a child with the experience of playing with a real makeup without the mess or toxicity associated with conventional cosmetic products. The synthetic cosmetics may further include a device for supporting the element, such as a container, compact, case or dispenser.

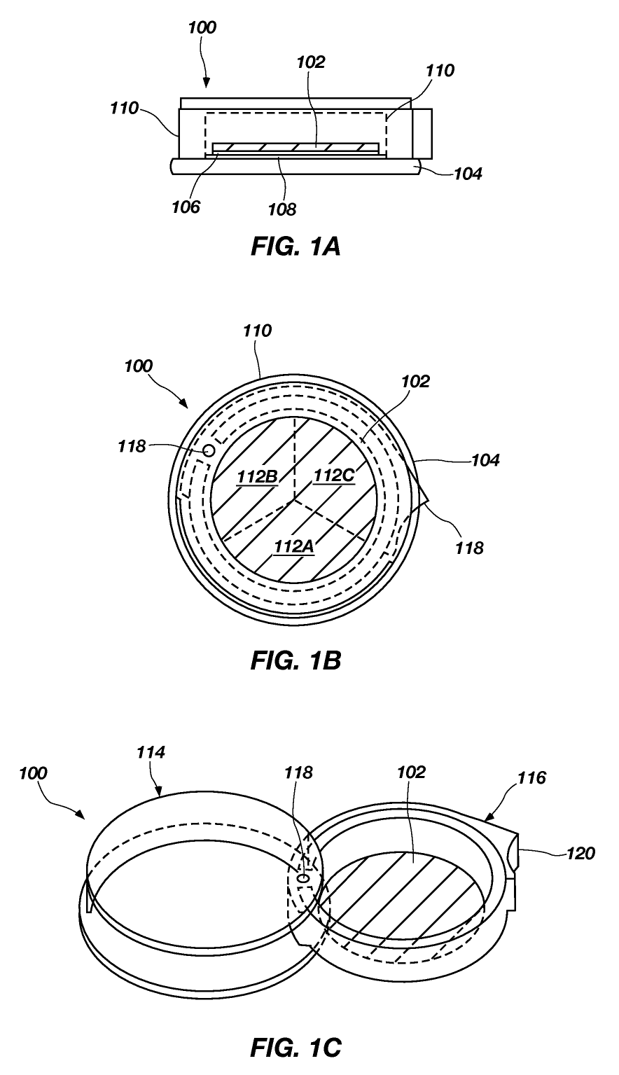

Referring now to FIGS. 1A-1C of the drawings, an embodiment of a simulated cosmetic 100 according to the present invention comprises an element 102 that simulates or approximates properties of a desired real cosmetic composition contained within a case 104. For example, the element 102 may be formed or selected to simulate or approximate the physical properties of a real cosmetic composition such as, for example, a powder cosmetic composition, a pressed powder cosmetic composition or cream cosmetic composition. As a non-limiting example, the element 102 may reproduce the physical properties of at least one of an eye shadow, a blush, a powder or cream foundation, a lip gloss, a lip balm, a bronzer, and the like. The element 102 may have at least one of a feel, an appearance, a color, a shade, a shape and a texture that approximates the properties of a particular cosmetic composition. For example, the element 102 may have a feel that is substantially similar to or the same as a real powder cosmetic composition or a real cream cosmetic composition. The element 102 may include a consolidated material that resists transfer and degradation upon contact. Since the element 102 may be repeatedly contacted without creating a mess or being degraded, it is ideal for use as a toy by a child. The element 102 may be formed from a soft, porous material to reproduce the feel of a cosmetic composition. By way of non limiting example, the element 102 may be formed from a foam material or a polymer material, such as, FOAMIES® craft foam, which is commercially available from Darice, Inc. (Strongsville, Ohio).

In some embodiments, the element 102 may be sized and configured to fit within the case 104 and may be adhered or affixed to a surface thereof. For example, an adhesive material 106 may be disposed between the element 102 and a base surface 108 of the case 104. As a non-limiting example, FOAMIES® sticky foam sheets, which include an adhesive backing, may be sized and configured to fit within walls 110 of the case 104 and may be disposed on and adhered to the base surface 108 thereof. The element 102 may be textured to reproduce a powdery, creamy, or velvety feel to the touch such as that associated with a real cosmetic composition. The element 102 may include a variety of colors to reproduce real cosmetic compositions, i.e., uses same color proportions and color materials. In some embodiments, a color of a desired real cosmetic composition may be recreated by the use of a color matching system, the details of which are known in the art and are not described in detail herein.

Currently, various real cosmetic compositions include ingredients, such as mica flakes or mineral powders, to create a glitter-like or shimmery effect. The element 102 may be used to replicate a cosmetic composition including such ingredients. For example, a glitter material or mica material may be incorporated into or consolidated with the element 102 to create the desired appearance and texture.

Referring to FIG. 1B, the element 104 may include a single, consolidated material or, optionally, may include a plurality of materials 112A, 112B and 112C, as shown in broken lines in FIG. 1B. Each of the materials 112A, 112B and 112C may have different physical properties, each simulating a real cosmetic composition having a different type, texture, color or shade. For example, each of the materials 112A, 112B and 112C may be formed from a polymer material having a similar texture and a different color to represent an eye shadow compact including a variety of differently colored eye shadows. As another non-limiting example, each of the materials 112A, 112B and 112C may include a polymer material having a similar texture and a different shade in the same color family the adjacent polymer materials to represent an eye shadow compact. For the sake of illustration, the element 114 shown in FIG. 1B includes three (3) materials 112A, 112B and 112C. It is to be understood that any number of materials may be used to simulate various types of cosmetics. For example, the element 104 may be formed from two (2) materials to simulate a duo lip color, a due eye color, and the like.

The case 104 may include a compact having a lid portion 114 and a body portion 116. The case 104, or a portion thereof, may be formed from a transparent or translucent material so that the element 102 is visible through the case 104. As a non-limiting example, the lid portion 114 of the case 104 may be moveably secured with the body portion 116 such that the case 104 may be easily opened and closed by a child. As shown in FIG. 1C, the lid portion 114 may be pivotally attached to the body portion 116 by way of a fastener 118, and may be configured to slide in and out of the body portion 116. The body portion 116 of the case 104 may, optionally, include a grip 120 that enables the case 104 to be easily opened.

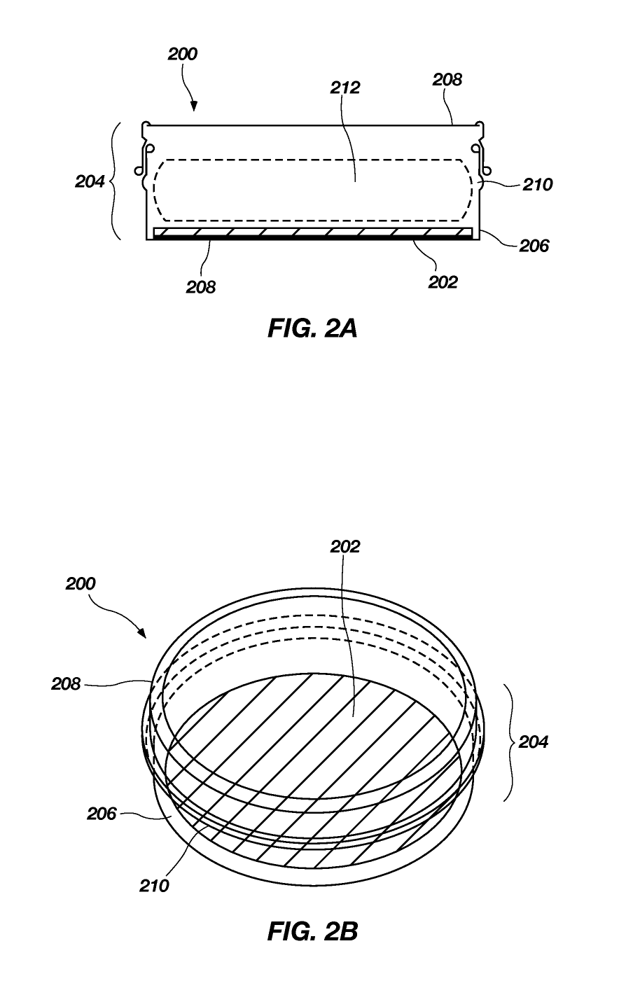

FIGS. 2A and 2B illustrate another embodiment of a simulated cosmetic 200 that approximates the characteristics of a pressed powder cosmetic product according to the present invention. The simulated cosmetic 200 may include, for example, an element 202 approximating or simulating the physical properties of a real cosmetic composition and a compact 204 for supporting the element 202. The element 202 may be formed to simulate, for example, the color, appearance, feel and texture of the pressed powder, as described with respect to FIGS. 1A-1C. For example, the element 200 may include a foam material or a polymer material, such as FOAMIES® polymer, and may be adhered or affixed within the compact 204, as described with respect to FIG. 1A.

The compact 204 may include a base portion 206 and a top portion 208, which are configured to be removably secured to one another. In some embodiments, the lid portion 208 may be fastened to the base portion 206 via a frictional fit. In other embodiments, the lid portion 208 may be moveably secured to the base portion 206 via a hinge assembly (not shown). The base portion 206 may, optionally, include a lip 210 having a diameter larger than a diameter of the lid portion 208 to hold the lid portion 208 in place. The compact 204 may be formed from a transparent or translucent material, or may have a transparent upper surface 205, as shown in FIG. 2B to enable a child to see the element 202 when the compact 204 is closed. The lid portion 208 of the compact 204 may optionally include a mirror or other reflective surface. Additionally, the simulated cosmetic 200 may include an applicator 212 such as, for example, a latex sponge or a powder puff, as shown in broken lines in FIG. 2A. The child may use the applicator 212 to contact the element 202 and, thus, enabling a child to mimic the application of the real cosmetic compositions by adults.

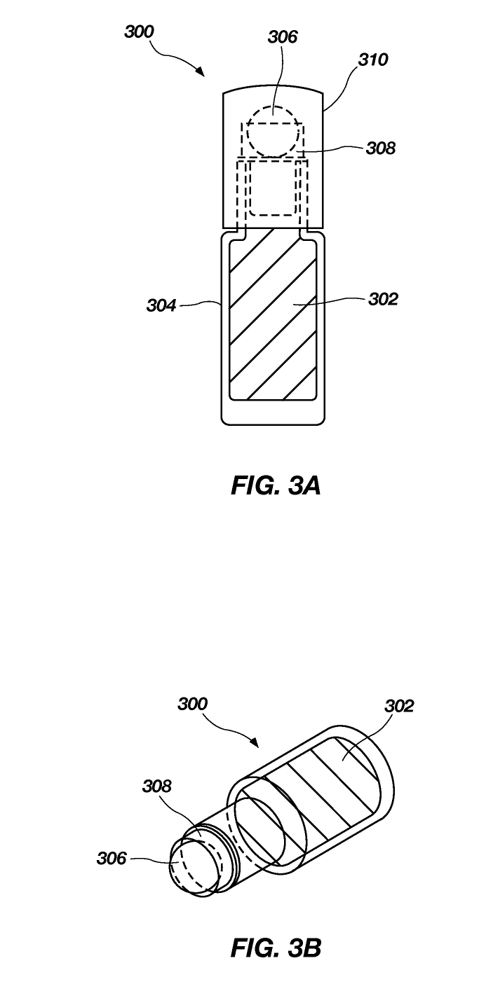

FIGS. 3A and 3B illustrate another embodiment of a simulated cosmetic 300 that approximates characteristics of a lip cosmetic, such as a lip color, a lip gloss, or a lip balm. The simulated cosmetic 300 may include an element 302 disposed within a dispenser 304, the element 302 selected to simulate or approximate an appearance and/or a color of a lip cosmetic. For example, the element 302 may be formed from a material in a solid-state, a liquid-state or a semi-solid state. If the material is a liquid or semi-solid, the dispenser 304 may be sealed such that the liquid or semi-solid material does not escape or leak from the dispenser 304 and, further, cannot be accessed by the child. The element 302 may be formed from a material capable of being cured or hardened such that the dispenser 304 may be easily filled with the material in a liquid or semi-solid state which is then hardened to form the element 302. The element 302 may further include a solid material such as, a fibrous material or a polymer material. The element 302 may be colored to create the appearance of a desired lip cosmetic. By way of non-limiting example, the dispenser 304 may be at least partially filled with a colored cotton material to reproduce the physical properties of the lip cosmetic.

The dispenser 304 may include, for example, a roller 306 permitting the child to simulate the feel of directly applying a real lip cosmetic. The roller 306 may be rotatably mounted in an upper portion 308 of the dispenser. In some embodiments, the roller 306 may be treated to approximate the feel of a gloss or a gel material. The roller is rotated by motion along the lips by the child to simulate application of a real lip cosmetic composition and, thus, utilizes the same physical dexterity as the real lip cosmetic composition. The dispenser 304, or a portion thereof, may be transparent so that the element 302 is visible. Optionally, the dispenser 304 may include a cap 310.

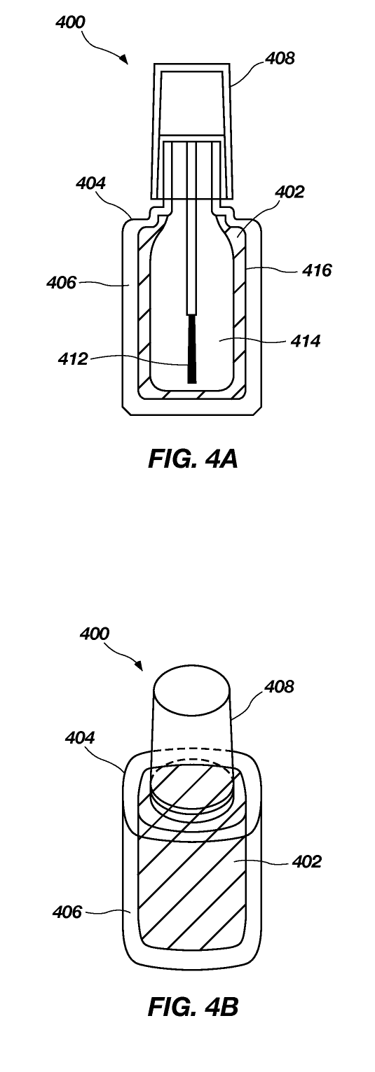

As shown in FIGS. 4A and 4B, an embodiment of a simulated nail polish 400 according to the present invention includes an element 402 that simulates or approximates physical properties of a real finger nail polish. For example, the element 402 may be formed from a solid material, a liquid material or a semi-solid material. If the material is a liquid or semi-solid, the dispenser 404 may be sealed such that the liquid or semi-solid material does not escape or leak from the dispenser 404 and, further, cannot be accessed by the child. By way of non-limiting example, the element 402 may be formed from materials capable of being cured or hardened such as waxes, monomers, oligomers, polymers, copolymers, epoxy resins and alginates. The material used to form the element 402 may be colored as desired by adding a colorant, such as a pigment or an ink, thereto. To enhance the experience of applying the simulated nail polish 400, the element 402 may be provided within a conventional nail polish dispenser 404 that includes a transparent or translucent plastic or glass bottle 406 and an attachable cap 408 having a built-in brush 412. As shown in FIG. 4A, the element 402 may include a cavity or void 414 that enables the brush to be disposed within the element 402.

To form the element 402 within the bottle 406, the bottle 406 may be at least partially filled with the material capable of being cured or hardened. With the material in an uncured or semi-uncured state, the bottle 406 may be rotated to coat the inner surfaces 416 with the material and to create a cavity or void 414 in the material positioned substantially in the center of the bottle 406. The material may be cured or hardened to form the element 402 having a void 414 that enables the brush 412 built-in to the cap 408 to be housed therein.

A number of the simulated cosmetics described herein may be grouped to form a cosmetics kit for use as a toy by a child. The kit may additionally include a set of applicators, such as conventional cosmetic brushes similar or identical to those used by adults, to enhance the realism of the simulated cosmetics and, accordingly, to improve the child's play experience. The simulated cosmetics of the present invention provide a play-makeup experience for a child without skin irritation or allergic reaction and without the risk of damaging furniture, carpets or clothing.

While the present invention has been described in terms of certain illustrated embodiments and variations thereof, it will be understood and appreciated by those of ordinary skill in the art that the invention is not so limited. Rather, additions, deletions and modifications to the illustrated embodiments may be effected without departing from scope of the invention as defined by the claims that follow, and their legal equivalents.

What is claimed is:

1. A simulated cosmetic toy, comprising an element having a feel approximating that of a cosmetic product.

2. The simulated cosmetic toy of claim 1, wherein the feel of the element simulates at least one of a powder, a cream and a pressed powder.

3. The simulated cosmetic toy of claim 1, wherein the element comprises at least one of a polymer material and a foam material.

4. The simulated cosmetic toy of claim 1, wherein the element comprises a consolidated material that resists degradation and transfer upon contact.

5. The simulated cosmetic toy of claim 1, wherein the element comprises a plurality of materials, each having different physical properties.

6. The simulated cosmetic toy of claim 5, wherein the plurality of materials each have a different color.

7. The simulated cosmetic toy of claim 1, wherein the element comprises at least one material providing the appearance of a glitter.

8. The simulated cosmetic toy of claim 1, further comprising a case, the element being disposed in the case and adhered to an inner base surface of the case.

9. The simulated cosmetic toy of claim 1, further comprising at least one applicator for contacting the element.

10. A simulated cosmetic toy, comprising an element simulating at least one of an appearance of a cosmetic composition disposed within container, the container comprising at least one apparatus for applying the cosmetic composition being simulated.

11. The simulated cosmetic toy of claim 10, wherein the element simulating at least one of an appearance of a cosmetic composition is formulated to simulate a liquid cosmetic product.

12. The simulated cosmetic toy of claim 10, wherein at least one apparatus for applying the cosmetic composition being simulated comprises a roller rotatably mounted within the container.

13. The simulated cosmetic toy of claim 12, wherein the roller has a surface that simulates the feel of a lip cosmetic.

14. The simulated cosmetic toy of claim 10, wherein at least one apparatus for applying the cosmetic composition being simulated comprises a brush affixed to a cap of the container.

15. The simulated cosmetic toy of claim 14, wherein the element is disposed within the container and comprises a void sized and configured to receive the brush.

16. The simulated cosmetic toy of claim 14, wherein the element comprises a colorant.

17. A method for producing a simulated cosmetic toy comprising:
selecting an element to approximate at least one of the appearance and feel of a real cosmetic product; and
disposing the element in a container.

18. The method of claim 17, wherein selecting an element to approximate at least one of the appearance and feel of a real cosmetic product comprises selecting an element having a feel that simulates at least one of a powder composition and a cream composition.

19. The method of claim 18, wherein selecting an element having a feel that simulates at least one of a powder composition and a cream composition comprises selecting a foam material having a porous surface.

20. The method of claim 17, wherein disposing the element in a container comprises:
pouring a material into the container in a flowable state;
dispersing the material on inner surfaces of the container to create a void in a substantially central region of the curable material; and
curing or hardening the material.
